(19) United States
(12) Patent Application Publication
(10) Pub. No.: US 2019/0303599 A1
(43) Pub. Date: Oct. 3, 2019

(54) Device Management Server, Device Management System, and Device Management Method

(71) Applicant: Kyocera Document Solutions Inc., Osaka (JP)

(72) Inventor: Chika Tsuji, Osaka (JP)

(73) Assignee: Kyocera Document Solutions Inc.

(21) Appl. No.: 16/364,196

(22) Filed: Mar. 26, 2019

(30) Foreign Application Priority Data
Mar. 28, 2018 (JP) 2018-061489

(51) Int. Cl. G06F 21/62; G06F 21/45; G06F 21/60

(52) U.S. Cl. CPC G06F 21/629; G06F 2221/2141; G06F 21/604; G06F 21/45

(57) ABSTRACT

A device management server includes a user management unit, a code issuance accepting unit, a grant requisition accepting unit, and a grant processing unit. The user management unit permits a user to access a belonging group of the user and a sub group of the belonging group based on group structure information. The code issuance accepting unit accepts an issuance of a code corresponding to the user to be a grant target person for a special access authority to the special region group. The grant requisition accepting unit accepts an input of the issued code and the special region group to accept a grant requisition for the special access authority. The grant processing unit grants the special access authority to the special region group to the user corresponding to the issued code when the grant requisition for the special access authority is accepted by the grant requisition accepting unit.

### INCORPORATION BY REFERENCE

This application is based upon, and claims the benefit of priority from, corresponding Japanese Patent Application No. 2018-061489 filed in the Japan Patent Office on Mar. 28, 2018, the entire contents of which are incorporated herein by reference.

### BACKGROUND

Unless otherwise indicated herein, the description in this section is not prior art to the claims in this application and is not admitted to be prior art by inclusion in this section.

A sales company of image forming apparatus, such as a copier and a multi-functional peripheral, sometimes enters into a maintenance contract with a customer and performs maintenance and management of an image forming apparatus in a customer environment. In a sales company having a plurality of sales bases, each sales base enters into a contract with a customer and performs maintenance of the image forming apparatus. Therefore, there is known a device management system that manages the respective sales bases of the sales company in a hierarchical structure as groups and can centrally manage the image forming apparatuses of the customers managed by the sales company and the respective sales bases.

### SUMMARY

A device management server according to one aspect of the disclosure includes a user management unit, a code issuance accepting unit, a grant requisition accepting unit, and a grant processing unit. The user management unit permits a user to access a belonging group of the user and a sub group of the belonging group based on group structure information. The group structure information includes a sales company group, a plurality of sales base groups, a customer group, and a special region group. The sales company group is a belonging group of a user of a sales company selling a plurality of image forming apparatuses. The plurality of sales base groups are located for respective sales bases under the sales company group and are belonging groups of users belonging to the sales bases. The customer group is located for each customer under the sales base groups and associated with the image forming apparatuses of the customer as a management target of the sales base. The special region group is located under the customer group and associated with the image forming apparatus as the management target located in a region outside an area of responsibility of the sales base. The code issuance accepting unit accepts an issuance of a code corresponding to the user to be a grant target person for a special access authority to the special region group. The grant requisition accepting unit accepts an input of the issued code and the special region group to accept a grant requisition for the special access authority. The grant processing unit grants the special access authority to the special region group to the user corresponding to the issued code when the grant requisition for the special access authority is accepted by the grant requisition accepting unit. The user management unit permits the user having been granted the special access authority by the grant processing unit to access the special region group even when the special region group is outside the belonging group and the sub group of the belonging group.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a system configuration of a device management system according to one embodiment of the disclosure;

FIG. 2 illustrates a schematic configuration of a device management server according to the one embodiment;

FIG. 3 illustrates an exemplary registration of group structure information illustrated in FIG. 2;

FIG. 4 illustrates an exemplary registration of user information DB illustrated in FIG. 2;

FIG. 5 illustrates an example of a code issuance accepting screen;

FIG. 6 illustrates an example of a grant requisition accepting screen of a special access authority; and

FIG. 7 illustrates a flow of a special access authority grant processing of the device management system according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an embodiment of the disclosure in detail with reference to the accompanying drawings. In the following embodiment, like reference numerals are designated to configurations that indicate similar functions.

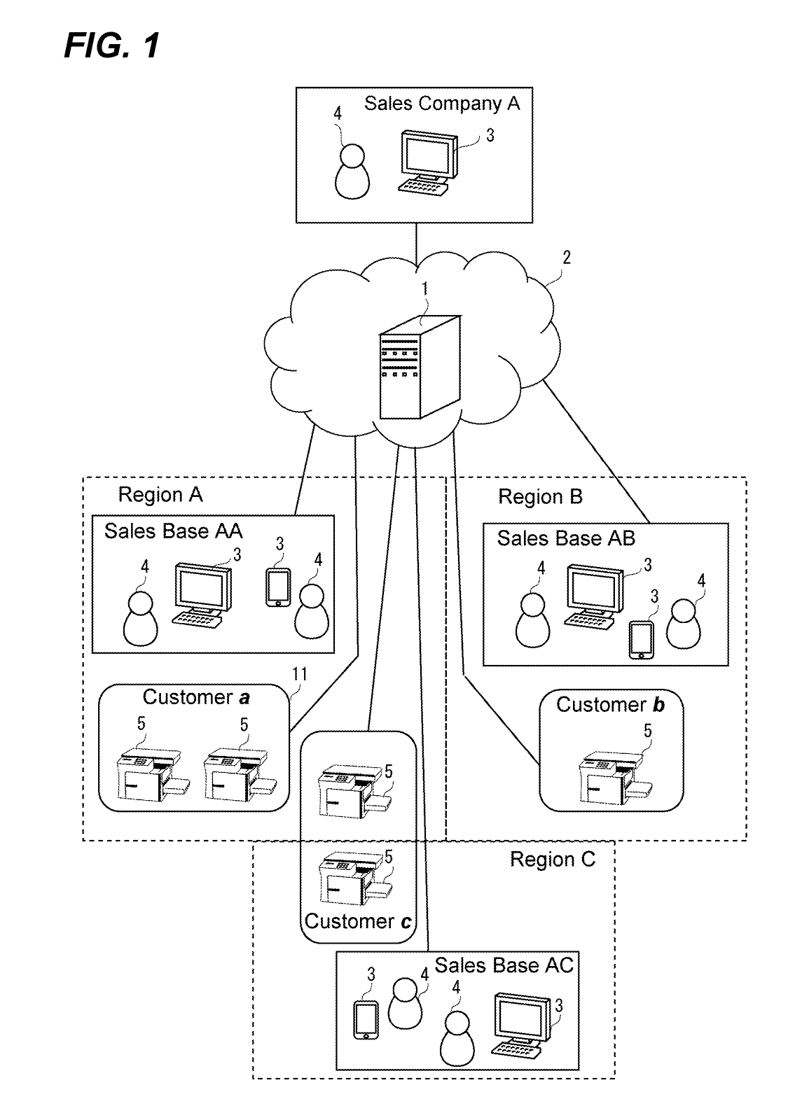

With reference to FIG. 1, a description will be given of a system configuration in a device management system according to the embodiment. The device management system includes a device management server 1 located on a cloud, a plurality of image forming apparatuses 5 such as a copier and a multi-functional peripheral installed in a customer environment as a management target, and a plurality of user terminals 3 that users 4 at a sales company A, sales bases AA, AB, and AC of the image forming apparatuses 5 use. The device management server 1 is connected to the plurality of image forming apparatuses 5 as the management target and the plurality of user terminals 3 via a network 2.

Next, a description will be given of a sales and maintenance management structure of the image forming apparatuses 5. The sales company A that performs manufacturing and sales of the image forming apparatus 5 has, as a sales base, the sales base AA located in a region A, the sales base AB located in a region B, and the sales base AC located in a region C.

Each of the sales bases AA, AB, and AC enters into a sales and maintenance contract of the image forming apparatuses 5 with a customer and performs maintenance and management of the image forming apparatuses 5 of the customer that has contracted, as the management target. In FIG. 1, the sales base AA has entered into a contract with a customer a, the sales base AB has entered into a contract with a customer b, and the sales base AC has entered into a contract with a customer c.

The customer a has buildings and shops in the region A and installs the image forming apparatuses 5 as the management target in the region A. The customer b has buildings and shops in the region B and installs the image forming apparatuses 5 as the management target in the region B. The customer c has buildings and shops in each of the region A and the region C and installs the image forming apparatuses 5 as the management target in both the region A and region C. Accordingly, although an area of responsibility of the sales base C is the region C, the sales base C needs to perform maintenance and management of the image forming apparatuses 5 installed in both the region A and region C for the customer c.

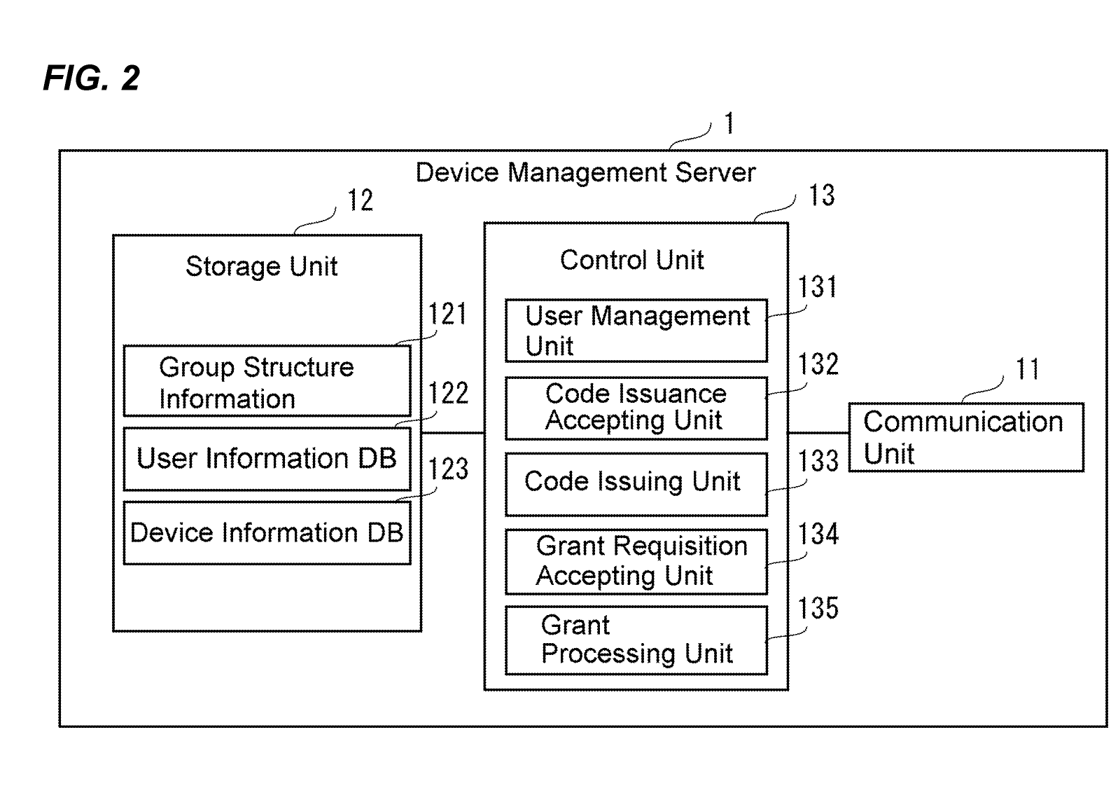

As illustrated in FIG. 2, the device management server 1 includes a communication unit 11, a storage unit 12, and a control unit 13. The device management server 1 can function as a Web server.

The communication unit 11 has a function to transmit and receive various kinds of data to and from the respective user terminals 3 and image forming apparatuses 5 via the network 2 such as a Local Area Network (LAN) or the Internet.

The storage unit 12 is a storage unit such as a semiconductor memory and a Hard Disk Drive (HDD), and stores device information DB 123, user information DB 122, and group structure information 121. The device information DB 123 and the user information DB 122 each may be located to be accessible from the device management server 1 via the network 2, as an external server.

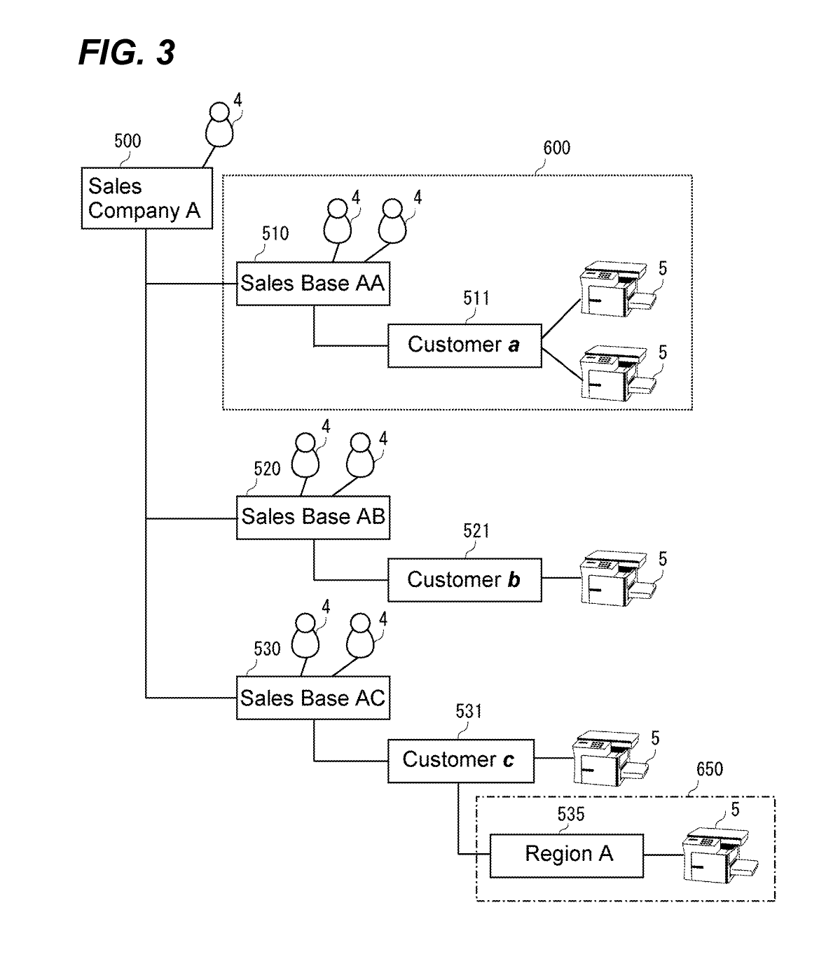

The group structure information 121 registers a group structure resembling an actual sales structure for the image forming apparatus 5. For example, as illustrated in FIG. 3, respective organizations constituting the actual sales structure of the image forming apparatus 5 are registered in a hierarchical structure.

FIG. 3 illustrates the group structure registered based on the sales structure illustrated in FIG. 1. The group structure includes a group 500 (a sales company group) indicating the sales company A, a group 510 (a sales base group) indicating the sales base AA, a group 520 (the sales base group) indicating the sales base AB, a group 530 (the sales base group) indicating the sales base AC, a group 511 (a customer group) indicating the customer a, a group 521 (the customer group) indicating the customer b, and a group 531 (the customer group) indicating the customer c.

Under the group 500 indicating the sales company A, as a sub group, the group 510 indicating the sales base AA, the group 520 indicating the sales base AB, and the group 530 indicating the sales base AC are located. Then, under the group 510 indicating the sales base AA, as the sub group, the group 511 indicating the customer a that has entered into the contract is located. Similarly, under the group 520 indicating the sales base AB, as the sub group, the group 521 indicating the customer b that has entered into the contract is located. Under the group 530 indicating the sales base AC, as the sub group, the group 531 indicating the customer c that has entered into the contract is located. Furthermore, under the group 531 indicating the customer c, a special region group 535 indicating the region A that is outside the area of responsibility for the sales base AC is located as the sub group.

The sales structure illustrated in FIG. 1 is one example, and when, for example, the sales bases AA, AB, and AC have a sub sales organization such as a dealer, under the sales bases AA, AB, and AC, the sub groups indicating the sub sales organization such as a dealer may be located. In this case, a customer of the dealer is located as the sub group of the group indicating the dealer.

In the device information DB 123, the device information of the respective image forming apparatuses 5 as the management target is registered. For example, the device information includes a serial number, expendables information such as toner, an error log, and a belonging group. The belonging group is a group that indicates an owner of the image forming apparatuses 5. For example, the belonging group of the image forming apparatuses 5 of the customer a is the group 511 indicating the customer a.

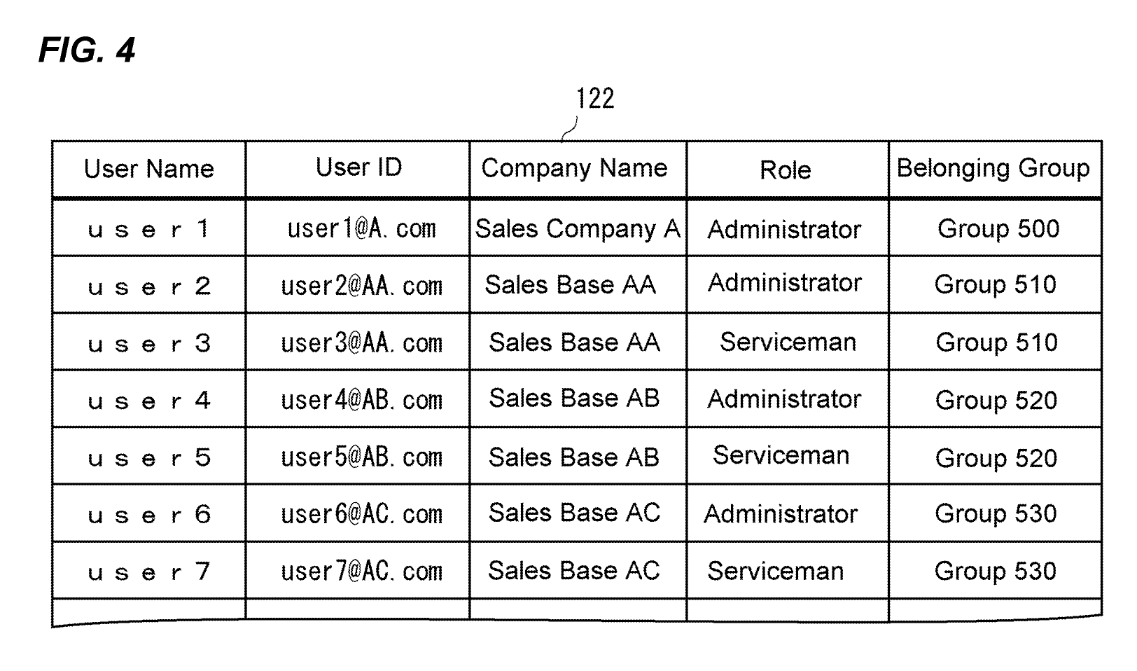

In the user information DB 122, the user information of the respective users 4 belonging to the sales company A, the sales bases AA, AB, and AC is registered. For example, as illustrated in FIG. 4, the user information includes user names, user IDs (for example, e-mail addresses), company names, roles of the respective users 4 such as an administrator or a serviceman, the belonging groups. A password used for user authentication and the user information of the customer may be included in the user information DB 122. The belonging group is a group that corresponds to the company to which the users 4 belong. For example, for the user 4 of the sales company A, the belonging group is the group 500.

Thus, the respective image forming apparatuses 5 registered in the device information DB 123 and the respective users 4 registered in the user information DB 122 are associated with any of the group registered in the group structure information 121 as the belonging group and managed.

The control unit 13 is connected to each of the communication unit 11 and the storage unit 12. The control unit 13 is an information processing unit such as a microcomputer that includes a Central Processing Unit (CPU), a Read Only Memory (ROM), a Random Access Memory (RAM), and similar component. The ROM stores control programs for performing an operation control of the device management server 1. The control programs may be recorded on a computer-readable recording medium and provided to the control unit 13. The CPU of the control unit 13 performs the control of the whole device management server 1 by reading the control programs stored in the ROM and executing the control programs after loading the control programs into the RAM.

The control unit 13 functions as a user management unit 131, a code issuance accepting unit 132, a code issuing unit 133, an access authority addition accepting unit, and an access authority addition unit.

The user management unit 131 has the functions of checking the user information input via the communication unit 11 against the user information DB 122 to perform the user authentication, causing the user 4 that has been succeeded in the authentication to login, and permitting the use of the functions of the device management server 1 within the authority permitted to the user 4.

For example, an accessible group range is determined for the respective users 4 depending on a position of the belonging group inside the group structure information 121, and the respective users 4 can access to the belonging group and the sub group (including a sub group of the sub group) of the belonging group. Consequently, the respective users 4 can refer to the image forming apparatus 5 associated with the belonging group and the image forming apparatus 5 associated with the sub group of the belonging group. The access to an upper group of the belonging group and a group of a sales line different from the belonging group is restricted.

For example, as illustrated in FIG. 3, the accessible group range for the serviceman and the administrator of the sales base AA is the image forming apparatuses 5 associated with the group 510 indicating the sales base AA and the image forming apparatuses 5 associated with the group 511 indicating the customer a. The accessible group range for the serviceman and the administrator of the sales base AC is the image forming apparatuses 5 associated with the group 530 indicating the sales base AC and the image forming apparatuses 5 associated with the group 531 indicating the customer c. The respective servicemen can refer to and remotely manage the device information of the image forming apparatuses 5 of the customer as the management target of the belonging sales base by logging in to the device management server 1.

At least one administrator residing in the respective groups has an administrator authority, can register a new group (for example, a group indicating a customer that has contracted, a group indicating a region outside the area of responsibility) under the belonging group, and can associate the image forming apparatuses 5 with the registered group. The administrator of the respective groups can grant a special access authority specially permitting the access to the group designated from among the belonging group and the sub group of the belonging group, with respect to the users 4 in the other groups.

This, for example, enables the administrator of the sales base AC to integrate the image forming apparatuses 5 of the customer c installed in the region A, which is outside the area of responsibility, into the special region group 535 and grant the special access authority to the special region group 535 to the serviceman of the sales base AA. The serviceman of the sales base AA having been granted the special access authority to the special region group 535, of the image forming apparatuses 5 of the customer c of the sales base AC, access to which is originally impossible, can refer to only the image forming apparatuses 5 associated with the special region group 535. That is, the administrator of the sales base AC can disclose only the device information of the image forming apparatuses 5 installed in the region outside the area of responsibility to the serviceman of the sales base AA and can request maintenance from the serviceman of the sales base AA in a state where security is ensured.

Granting the special access authority to the belonging group and the sub group of the belonging group freely to the users 4 of the other groups by the administrator of the respective groups sometimes causes a security problem. Therefore, this embodiment enables the administrator of a highest group in the group structure information 121 to issue a code necessary to grant the special access authority and restricts such that the administrator of the respective groups can grant the special access authority by using the issued code.

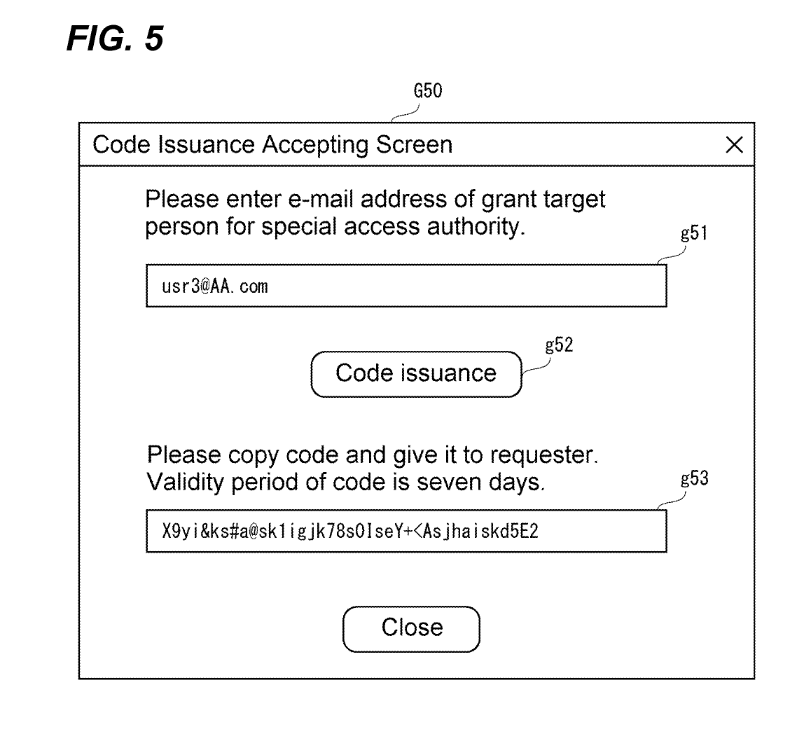

The code issuance accepting unit 132 has a function to accept the input from the user 4 to be a grant target person for the special access authority and to accept the issuance of the code for the user 4 the input from whom has been accepted, via a code issuance accepting screen G50 illustrated in FIG. 5. The code issuance accepting screen G50 can be displayed by the administrator of the highest group in the group structure information 121. The reason for this is to prevent the administrator or similar person of the sub group from easily issuing the code to grant the special access authority.

The code issuance accepting screen G50 includes a user information entry field g51 to input the user information for the special access authority applicant, a code issuance button g52 to instruct a code issuance, and a code display field g53 where the issued code is displayed.

When the code issuance button g52 is pressed, the code issuing unit 133 issues a code and displays the issued code in the code display field g53. For security, the code is generated using a character string unpredictable for the user 4 and, for example, may be constituted of random alphanumeric characters. The code issuing unit 133 associates the issued code with the user information of the grant target person for the special access authority and stores in the storage unit 12 for a specified period (for example, one week). Restricting a period possible to grant the special access authority ensures the enhanced security.

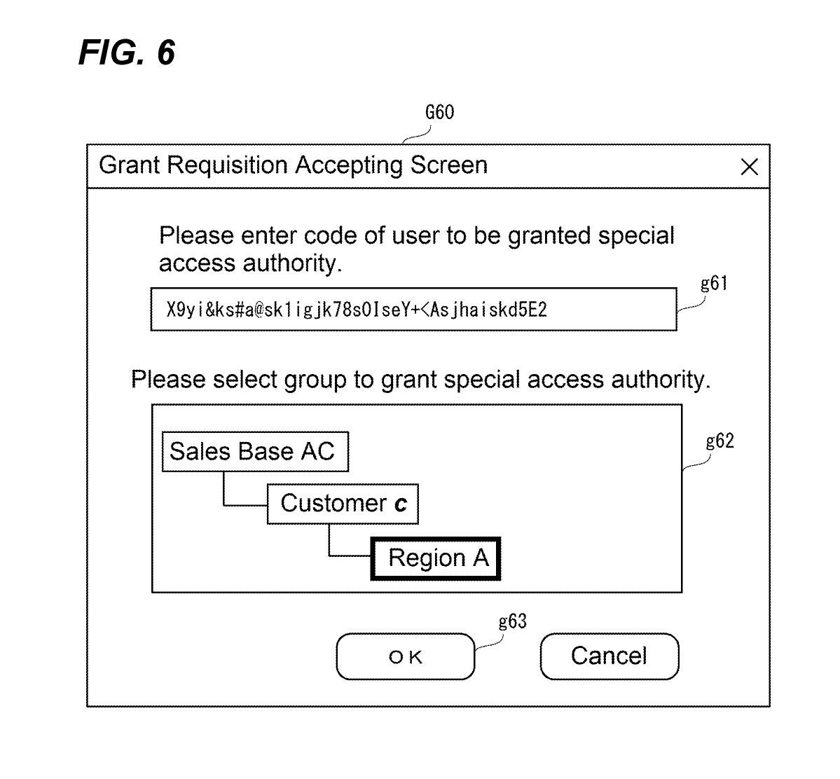

A grant requisition accepting unit 134, via a grant requisition accepting screen G60 illustrated in FIG. 6, has a function to accept the input of the code corresponding to the user 4 as the grant target person for the special access authority and to accept designation of a group to which the special access authority is granted to the user 4. The group can be designated from the belonging group of the administrator who has displayed the setting accepting screen as the grant requisition accepting screen G60 and the sub group of the belonging group.

The grant requisition accepting screen G60 includes a code entry field g61 to input the code corresponding to the grant target person for the special access authority, a group selection field g62 to input the group to be a grant target for the special access authority, and an OK button g63 to instruct the grant for the special access authority. The group selection field g62 displays a group to which the special access authority is grantable in the hierarchical structure based on the group structure information 121. When the administrator selects the group, the selected group is displayed in bold frame. For example, the grant requisition accepting screen G60 illustrated in FIG. 6 indicates that the group of region A has been selected by the administrator of the sales base AC.

When the OK button g63 is pressed, the special access authority granting unit (which is referred to as grant processing unit 135) identifies the user 4 to be the grant target person for the special access authority from the storage unit 12, based on the code entered in the code entry field g61, and grants the identified user 4 the special access authority to the group that has been selected in the group selection field g62. This enable the user 4 to whom the special access authority has been granted to have not only the access authority (a default access authority) relative to the belonging group and the sub group of the belonging group, which are the ordinary accessible group range, but also the access authority (the special access authority) relative to the group to which the special access authority has been granted.

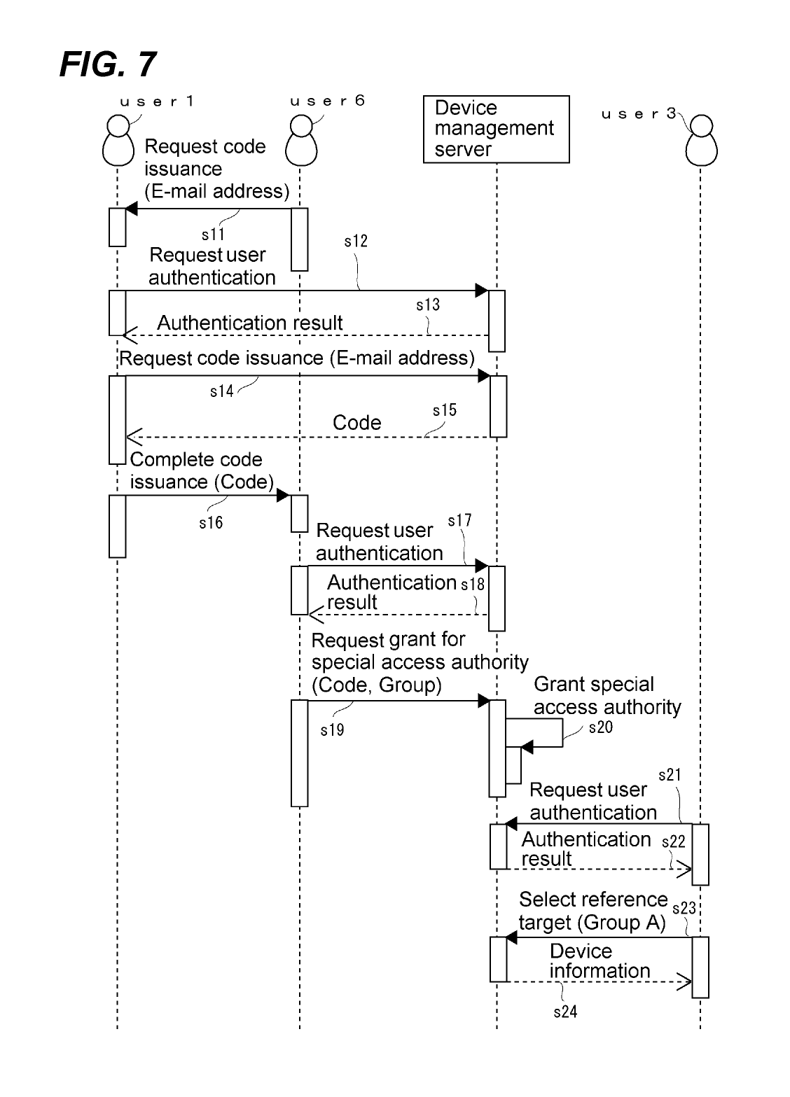

Next, with reference to FIG. 7, a description will be given of a flow where the special access authority is granted. Here, a description will be given of a case where a user 6 as the administrator of the sales base AC grants a user 3 as the serviceman of the sales base AA the special access authority for the special region group 535 corresponding to the region A, which is outside the area of responsibility.

First, the user 6, via the user terminal 3, transmits a code issuance request to the administrator (a user 1) of the sales company A, which is the highest group of the group structure information 121 (Step s11). The code issuance request includes the user information (the e-mail address of the serviceman of the sales base AA) of a person to be the grant target person for the special access authority. The code issuance request may be transmitted by an e-mail. Assume that the user 6 preliminarily knows the e-mail address of the user 3.

Subsequently, the user 1 having received the code issuance request, via the user terminal 3, transmits a user authentication requisition to the device management server 1 (Step s12). The user authentication requisition includes the user information identifying the user 1. The user management unit 131 of the device management server 1 executes the user authentication based on the user authentication requisition and transmits an authentication result to the user terminal 3 of the user 1 (Step s13).

Subsequently, the user 1 having succeeded in the user authentication obtains the code issuance accepting screen G50 from the device management server 1 and causes the user terminal 3 to display it, enter the e-mail address of the grant target person for the special access authority included in the code issuance request from the user 6 into the user information entry field g51, and presses the code issuance button g52. This performs a code issuance requisition to the device management server 1 (Step s14).

Subsequently, when the code issuance accepting unit 132 of the device management server 1, via the code issuance accepting screen G50, accepts the code issuance requisition, the code issuing unit 133 issues a code and displays the issued code on the code display field g53 (Step s15). The code issuing unit 133 associates the issued code with the user information having been entered in the user information entry field g51 and saves in the storage unit 12 for the specific period. The user 1, for example, copies and pastes the code displayed on the code display field g53, writes it in, for example, the e-mail, and gives a notice of completion of the code issuance to the user 6 (Step s16).

The user 6 having been given a notice of the code, via the user terminal 3, performs the user authentication requisition including own user information to the device management server 1 (Step s17). The user management unit 131 of the device management server 1, based on the user authentication requisition, executes the user authentication, and transmits the authentication result to the user terminal 3 of the user 6 (Step s18).

The user 6 having succeeded in the user authentication obtains the grant requisition accepting screen G60 from the device management server 1, causes the user terminal 3 to display it, selects the group to be the grant target for the access authority from the group selection field g62 as well as enters the code in the code entry field g61, and presses the OK button g63. This performs the grant requisition for the special access authority to the device management server 1 (Step s19).

Subsequently, when the grant requisition accepting unit 134 of the device management server 1, via the grant requisition accepting screen G60, accepts the grant requisition for the special access authority, a grant processing unit 135 identifies the grant target person for the special access authority based on the code entered into the code entry field g61 and grants the identified applicant the special access authority to the group selected at the group selection field g62 (Step s20).

By checking the code entered into the code entry field g61 against the code stored in the storage unit 12, the grant processing unit 135 can identify the user 3 corresponding to the code as the grant target person for the special access authority. When the code having been entered into the code entry field g61 has not been able to be checked against the code in the storage unit 12 because of an error or an expiration, the grant processing unit 135, via the grant requisition accepting screen G60, may give a notice of a failure of the grant. When the special access authority has been able to be granted successfully, the grant processing unit 135, via the grant requisition accepting screen G60, may give a notice of the success of the grant. The grant processing unit 135 may give a notice of a permitted access to the special region group 535 to the user that has been granted the special access authority by, for example, an e-mail.

Subsequently, the user 3, via the user terminal 3, performs the user authentication requisition including own user information to the device management server 1 (Step s21). The user management unit 131 of the device management server 1, based on the user authentication requisition, executes the user authentication and transmits the authentication result to the user terminal 3 of the serviceman of the sales base AA (Step s22).

Subsequently, the user 3, via the user terminal 3, selects the special region group 535 to which the special access authority has been granted as a reference target (Step s23). Because the special access authority to the special region group 535 has been granted to the user 3 by the grant processing unit 135, the user management unit 131 of the device management server 1 permits the user 3 to access the special region group 535 and causes the user terminal 3 of the user 3 to display the device information of the image forming apparatuses 5 of the customer c, which have been associated with the special region group 535 (Step s24).

Thus, the processing terminates. This enables the user 3 that has been granted the special access authority can refer to not only the image forming apparatuses 5 included in a default accessible range 600 illustrated in FIG. 3 but also the image forming apparatuses 5 included in an accessible range 650 based on the special access authority. Accordingly, the user 3 can confirm the device information of the image forming apparatuses 5 of the customer c that are associated with the special region group 535, to which the access is not originally permitted, and can alternatively perform the maintenance of the image forming apparatuses 5 of the customer c, which the sales base AC sets as the management target.

Thus, the device management server 1 according to the embodiment includes the user management unit 131, the code issuance accepting unit 132, the grant requisition accepting unit 134, and the grant processing unit 135. The user management unit 131 permits the users 4 to access the belonging group of the users 4 and the sub group of the belonging group based on the group structure information 121. The group structure information 121 includes: the sales company group (the group 500) that is the belonging group of the users 4 of the sales company A selling the plurality of image forming apparatuses 5; the plurality of sales base groups (the groups 510, 520, and 530) that are located for respective sales bases under the sales company group and are the belonging group of the users 4 that belong to the sales base; the customer groups (the groups 511, 521, and 531) that are located for respective customers under the sales base group and associated with the image forming apparatuses 5 of the customers as the management target of the sales base; and the special region group 535 that is located under the customer group and associated with the image forming apparatuses 5 as the management target located in the region outside the area of responsibility of the sales base. The code issuance accepting unit 132 accepts the issuance of the code corresponding to the user 4 to be the grant target person for the special access authority to the special region group 535. The grant requisition accepting unit 134 accepts the input of the issued code and the special region group 535 and accepts the grant requisition for the special access authority. When the grant requisition for the special access authority is accepted by the grant requisition accepting unit 134. The grant processing unit 135 grants the special access authority to the special region group 535 to the user 4 corresponding to the issued code. The user management unit 131 permits the user 4 having been granted the special access authority by the grant processing unit 135 to access the special region group 535 even when the special region group 535 is not included in the belonging group and the sub group of the belonging group.

This enables the administrator of the sales base AC, with respect to the image forming apparatuses 5 that are the management target and are installed in a region outside the area of responsibility, to grant the special access authority to the special region group 535 to the serviceman of the sales base AA that are in charge of this area, and thus, to disclose the device information by limiting to the image forming apparatuses 5 that are the management target and are installed in the region outside the area of responsibility. Therefore, this ensures a request for alternatively performing maintenance for the image forming apparatuses 5 associated with the special region group 535 to the serviceman of the sales base AA, while considering security.

The special access authority is only a reference authority to the group and need not have a change authority such as write. In performing the grant requisition for the special access authority, the administrator may be able to set an authority range for the special access authority.

### Exemplary Embodiment of the Disclosure

A device management server of the disclosure includes: a user management unit that permits a user to access a belonging group of the user and a sub group of the belonging group based on group structure information, the group structure information including a sales company group, a plurality of sales base groups, a customer group, and a special region group, the sales company group being a belonging group of a user of a sales company selling a plurality of image forming apparatuses, the plurality of sales base groups being located for respective sales bases under the sales company group and being belonging groups of users belonging to the sales bases, the customer group being located for each customer under the sales base groups and associated with the image forming apparatuses of the customer as a management target of the sales base, the special region group being located under the customer group and associated with the image forming apparatus as the management target located in a region outside an area of responsibility of the sales base; a code issuance accepting unit that accepts an issuance of a code corresponding to the user to be a grant target person for a special access authority to the special region group; a grant requisition accepting unit that accepts an input of the issued code and the special region group to accept a grant requisition for the special access authority; and a grant processing unit that grants the special access authority to the special region group to the user corresponding to the issued code when the grant requisition for the special access authority is accepted by the grant requisition accepting unit. The user management unit permits the user having been granted the special access authority by the grant processing unit to access the special region group even when the special region group is outside the belonging group and the sub group of the belonging group.

The device management server may include a code issuing unit that issues the code and saves the issued code for a specified period by associating the issued code with the user to be the grant target person for the special access authority when the issuance of the code is accepted by the code issuance accepting unit. The grant processing unit may identify the user to be the grant target person for the special access authority by checking the code an input of which has been accepted by the grant requisition accepting unit against the code saved by the code issuing unit.

The code issuance accepting unit may accept the issuance of the code by an administrator authority of a highest group in the group structure information. The grant requisition accepting unit may accept the grant requisition for the special access authority by an administrator authority of the sales base group.

The grant processing unit may give a notice of permission of the access to the special region group to the user that has been granted the special access authority.

A device management system of the disclosure is a device management system where a device management server is connected to a plurality of image forming apparatuses and a plurality of user terminals via a network. The plurality of image forming apparatuses are remotely managed via the network by the device management server. The respective user terminals execute a user authentication with the device management server. The device management server includes: a user management unit that permits a user to access a belonging group of the user and a sub group of the belonging group based on group structure information, the group structure information including a sales company group, a plurality of sales base groups, a customer group, and a special region group, the sales company group being a belonging group of a user of a sales company selling a plurality of image forming apparatuses, the plurality of sales base groups being located for respective sales bases under the sales company group and being belonging groups of users belonging to the sales bases, the customer group being located for each customer under the sales base groups and associated with the image forming apparatuses of the customer as a management target of the sales base, the special region group being located under the customer group and associated with the image forming apparatus as the management target located in a region outside an area of responsibility of the sales base; a code issuance accepting unit that accepts an issuance of a code corresponding to the user to be a grant target person for a special access authority to the special region group; a grant requisition accepting unit that accepts an input of the issued code and the special region group and accepts a grant requisition for the special access authority; and a grant processing unit that grants the special access authority to the special region group to the user corresponding to the issued code when the grant requisition for the special access authority is accepted by the grant requisition accepting unit. The user management unit permits the user having been granted the special access authority by the grant processing unit to access the special region group to even when the special region group is outside the belonging group and the sub group of the belonging group.

A device management method of the disclosure includes: a step of permitting a user to access a belonging group of the user and a sub group of the belonging group based on group structure information, the group structure information including a sales company group, a plurality of sales base groups, a customer group, and a special region group, the sales company group being a belonging group of a user of a sales company selling a plurality of image forming apparatuses, the plurality of sales base groups being located for respective sales bases under the sales company group and being belonging groups of users belonging to the sales bases, the customer group being located for each customer under the sales base groups and associated with the image forming apparatuses of the customer as a management target of the sales base, the special region group being located under the customer group and associated with the image forming apparatus as the management target located in a region outside an area of responsibility of the sales base; a step of accepting an issuance of a code corresponding to the user to be a grant target person for a special access authority to the special region group; a step of accepting an input of the issued code and the special region group to accept a grant requisition for the special access authority; and a step of granting the special access authority to the special region group to the user corresponding to the issued code when the grant requisition for the special access authority is accepted by the grant requisition accepting unit. The step of permitting includes permitting the user having been granted the special access authority by the step of granting to access the special region group even when the special region group is outside the belonging group and the sub group of the belonging group.

### Effect of the Disclosure

With the disclosure, a sales base having an image forming apparatus as a management target that resides in a region outside an area of responsibility can provide device information of the image forming apparatus to a serviceman of other sales bases, and thus, the sales base can request the serviceman of the other sales bases of maintenance of the image forming apparatus outside the area of responsibility.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A device management server comprising:
a user management unit that permits a user to access a belonging group of the user and a sub group of the belonging group based on group structure information, the group structure information including a sales company group, a plurality of sales base groups, a customer group, and a special region group, the sales company group being a belonging group of a user of a sales company selling a plurality of image forming apparatuses, the plurality of sales base groups being located for respective sales bases under the sales company group and being belonging groups of users belonging to the sales bases, the customer group being located for each customer under the sales base groups and associated with the image forming apparatuses of the customer as a management target of the sales base, the special region group being located under the customer group and associated with the image forming apparatus as the management target located in a region outside an area of responsibility of the sales base;
a code issuance accepting unit that accepts an issuance of a code corresponding to the user to be a grant target person for a special access authority to the special region group;
a grant requisition accepting unit that accepts an input of the issued code and the special region group to accept a grant requisition for the special access authority; and
a grant processing unit that grants the special access authority to the special region group to the user corresponding to the issued code when the grant requisition for the special access authority is accepted by the grant requisition accepting unit,
wherein the user management unit permits the user having been granted the special access authority by the grant processing unit to access the special region group even when the special region group is outside the belonging group and the sub group of the belonging group.

2. The device management server according to claim 1, further comprising
a code issuing unit that issues the code and saves the issued code for a specified period by associating the issued code with the user to be the grant target person for the special access authority when the issuance of the code is accepted by the code issuance accepting unit,
wherein the grant processing unit identifies the user to be the grant target person for the special access authority by checking the code an input of which has been accepted by the grant requisition accepting unit against the code saved by the code issuing unit.

3. The device management server according to claim 1,
wherein the code issuance accepting unit accepts the issuance of the code by an administrator authority of a highest group in the group structure information, and
the grant requisition accepting unit accepts the grant requisition for the special access authority by an administrator authority of the sales base group.

4. The device management server according to claim 1,
wherein the grant processing unit gives a notice of permission of the access to the special region group to the user that has been granted the special access authority.

5. A device management system where a device management server is connected to a plurality of image forming apparatuses and a plurality of user terminals via a network,
wherein the plurality of image forming apparatuses are remotely managed via the network by the device management server,
the respective user terminals execute a user authentication with the device management server,
the device management server includes:
a user management unit that permits a user to access a belonging group of the user and a sub group of the belonging group based on group structure information, the group structure information including a sales company group, a plurality of sales base groups, a customer group, and a special region group, the sales company group being a belonging group of a user of a sales company selling a plurality of image forming apparatuses, the plurality of sales base groups being located for respective sales bases under the sales company group and being belonging groups of users belonging to the sales bases, the customer group being located for each customer under the sales base groups and associated with the image forming apparatuses of the customer as a management target of the sales base, the special region group being located under the customer group and associated with the image forming apparatus as the management target located in a region outside an area of responsibility of the sales base;
a code issuance accepting unit that accepts an issuance of a code corresponding to the user to be a grant target person for a special access authority to the special region group;
a grant requisition accepting unit that accepts an input of the issued code and the special region group to accept a grant requisition for the special access authority; and
a grant processing unit that grants the special access authority to the special region group to the user corresponding to the issued code when the grant requisition for the special access authority is accepted by the grant requisition accepting unit,
wherein the user management unit permits the user having been granted the special access authority by the grant processing unit to access the special region group even when the special region group is outside the belonging group and the sub group of the belonging group.

6. A device management method comprising:
permitting a user to access a belonging group of the user and a sub group of the belonging group based on group structure information, the group structure information including a sales company group, a plurality of sales base groups, a customer group, and a special region group, the sales company group being a belonging group of a user of a sales company selling a plurality of image forming apparatuses, the plurality of sales base groups being located for respective sales bases under the sales company group and being belonging groups of users belonging to the sales bases, the customer group being located for each customer under the sales base groups and associated with the image forming apparatuses of the customer as a management target of the sales base, the special region group being located under the customer group and associated with the image forming apparatus as the management target located in a region outside an area of responsibility of the sales base;
accepting an issuance of a code corresponding to the user to be a grant target person for a special access authority to the special region group;
accepting an input of the issued code and the special region group to accept a grant requisition for the special access authority; and
granting the special access authority to the special region group to the user corresponding to the issued code when the grant requisition for the special access authority is accepted by the grant requisition accepting unit,
wherein the permitting includes permitting the user having been granted the special access authority by the granting to access the special region group even when the special region group is outside the belonging group and the sub group of the belonging group.
